(19) United States
(12) Patent Application Publication
(10) Pub. No.: US 2025/0307117 A1
(43) Pub. Date: Oct. 2, 2025

(54) ERROR CODE GENERATION FOR SOFTWARE APPLICATION EXECUTIONS

(71) Applicant: RED HAT, INC., Raleigh, NC (US)

(72) Inventors: Alexander Braverman Masis, Toronto (CA); Junqi Zhang, Westford, MA (US)

(21) Appl. No.: 18/618,115

(22) Filed: Mar. 27, 2024

(51) Int. Cl. G06F 11/36

(52) U.S. Cl. CPC G06F 11/3636; G06F 11/366

(57) ABSTRACT

Some examples of the present disclosure relate to error code generation for software application executions. In one particular example, a system can determine an error in an execution of a software application. The system can determine, based on a decision tree representing the software application, an error code associated with the error. The error code can be a subset of a plurality of identifiers indicating a path of the execution of the software application and data associated with the path. The system can perform an action in response to the error code.

### TECHNICAL FIELD

The present disclosure relates generally to software execution. More specifically, but not by way of limitation, this disclosure relates to generating error codes for software application executions.

### BACKGROUND

During development of a software application, various software tests (e.g., unit tests, integration tests, and system tests) may be performed on the software application to help ensure that the software application is free from defects or meets other requirements. Once software developers are satisfied that the software application is ready for release, the software developers may push the software application to a server or otherwise make the software application available to the end users. The end users may then download the software application to their computing devices and install the software application thereon. In some instances, the software application may still encounter errors when run by an end user.

### BRIEF DESCRIPTION OF THE DRAWINGS

FIG. 1 is a block diagram of an example of a system for error code generation for software application executions according to some aspects of the present disclosure.

FIG. 2 is an example of a decision tree for error code generation according to some aspects of the present disclosure.

FIG. 3 is a block diagram of another example of a system for error code generation for software application executions according to some aspects of the present disclosure.

FIG. 4 is a flow chart of an example of a process for error code generation for software application executions according to some aspects of the present disclosure.

### DETAILED DESCRIPTION

When a software application is executed, the execution may encounter an error for various reasons. For instance, the software application may not behave as intended and experience a functional error. Or, there may be errors in source code of the software application that go undetected during testing of the software application. Logic errors, calculation errors, system-level integration errors, and out of bounds errors may also occur. In any case, a user or a developer may use error codes, log entries and story writing to attempt to figure out a cause of an error. The combination of these methods may be hard to decipher the developer or software supporter. In addition, the combination may be difficult generalize into a document or other report that may be used to assist the user in deciphering and fixing the error. These methods typically indicate functions of the software application that were executed before the error occurred, but they lack any information about input data that was provided to the functions. As a result, the cause of the error may be challenging to detect and often requires developers to engage a manual, tedious, time consuming, and complex process to identify and resolve them.

Some examples of the present disclosure can overcome one or more of the abovementioned problems by providing a system that determines an error in an execution of a software application and uses a decision tree to determine an error code associated with the error. The error code can be a unique set of identifiers that indicates a path of the execution of the software application and data associated with the path. The path may also be referred to as a branch of the software application. The system can then perform an action in response to the error code. By generating an error code that indicates a path of the execution (e.g., where the software application failed) as well as the input data involved in the execution, a root cause of the error may be efficiently identified and mitigated. A user device may receive relevant documentation as to the error and its cause. In addition, a developer may gain insight to the unique scenario the computing device was experiencing at the time of the error. As a result, root cause analysis may be more efficient, ultimately requiring fewer computing resources. Moreover, software application and testing updates may also be more accurate and more efficient.

As a particular example, a system may include a calculator software application. When running the software application, an error may occur if a sum function of the software application receives an unexpected input. Using a decision tree with nodes that represent functions of the software applications and edges representing expected values for the functions, the system can generate an error code of “0-2-1”, which is a sequence of identifiers for the nodes and the edges that were executed before the error occurred. Since the error code not only represents the functions that were executed, but also the input data values during the execution, the error code may be more beneficial in the determination of a cause of the error than conventional error codes and log entries. For instance, once the error code is generated, the system may perform a lookup of a database to receive documentation associated with the error code. Or, the system may notify a user device of a software developer of the error code, and the developer can update the software application or a test suite associated with the software application so that the error may be avoided in subsequent executions of the software application.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

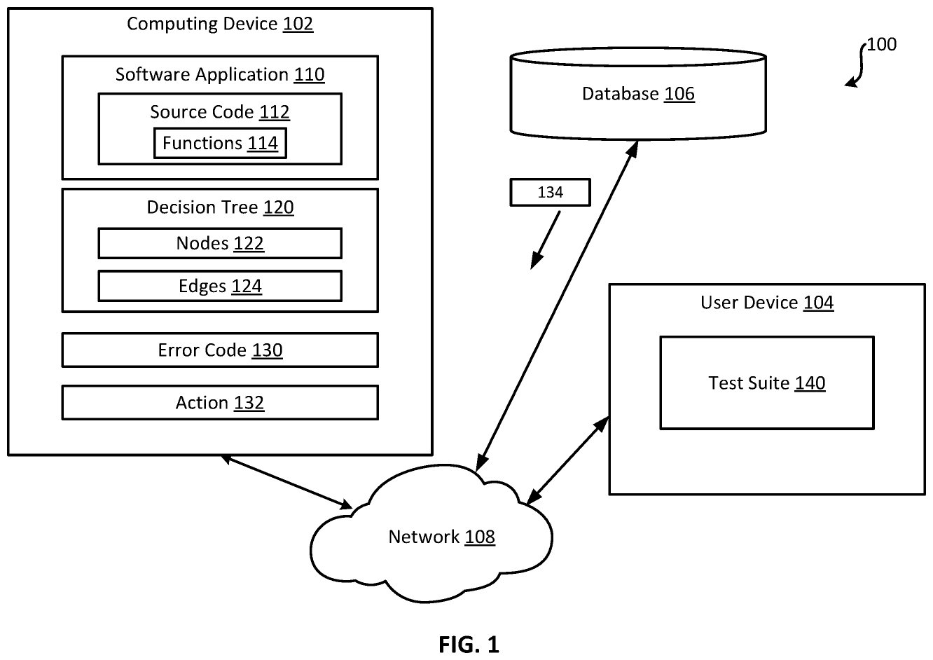

FIG. 1 is a block diagram of an example of a system for error code generation for software application executions according to some aspects of the present disclosure. The system 100 includes a computing device 102 communicatively coupled to a user device 104 and a database 106 via a network 108, such as a local area network (LAN), wide area network (WAN), the Internet, or any combination of these. The computing device 102 may be a desktop computer, laptop computer, mobile device, or server on which software applications can be executed. The computing device 102 may alternatively be an Internet of things (IoT) device that does not include a user interface display. A user may interact with the IoT device through governing software in the form of applications on a mobile phone, or web interface. The user device 104 may be a computing device (e.g., a desktop computer, laptop computer, mobile device, or server) on which one or more developers can create or edit working copies of source code for software.

In some examples, the computing device 102 includes a software application 110 that can be run on the computing device 102. The software application 110 may be downloaded and installed from a server to which a developer may upload the software application 110 after running a test suite 140 on the software application 110 to ensure that the software application 110 runs as expected and is free from defects. The software application 110 can have source code 112 that defines functions 114 for the software application 110.

The computing device 102 may include or otherwise access a decision tree 120 that represents the software application 110 and that can be used to determine an error code when the software application 110 encounters an error during execution. The decision tree 120 may be stored on the computing device 102, or the decision tree 120 may be external to the computing device 102, but accessible to the computing device 102. In some instances, the computing device 102 may receive the decision tree 120 when downloading the software application 110. The decision tree 120 can include nodes 122 and edges 124 that connect the nodes 122. The nodes 122 can represent the functions 114. That is, for each function included in the source code 112, the decision tree 120 can include a corresponding node. In addition, the edges 124 can represent a set of expected values for a function. The set of expected values may be defined by a developer during development of the software application 110. So, each edge represents a set of values that cause the software application 110 to execute different parts of its logic.

In some examples, each of the nodes 122 and each of the edges 124 can be associated with an identifier. So, as the software application 110 executes, a path of the execution can be followed from a root node representing a start of the program, through the functions that are executed based on data that is passed. This path of execution is represented by a unique subset of the identifiers of each of the nodes 122 and edges 124. The data can represent outputs of the executed functions that are used as the inputs to subsequent functions. If any of the outputs are unexpected, the software application 110 may encounter an error and fail. If this happens, the decision tree 120 can be used to generate an error code 130 that identifies the path of execution and the data.

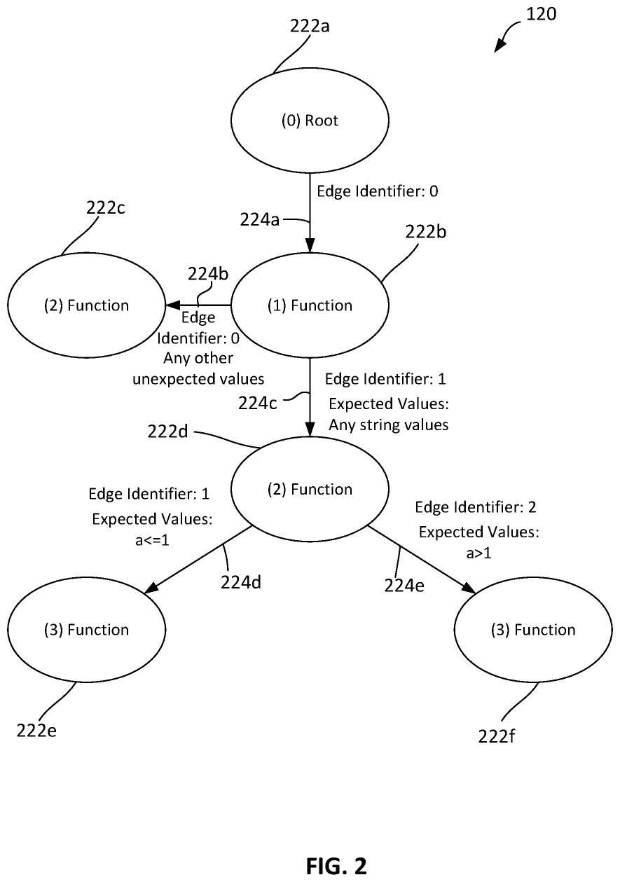

FIG. 2 illustrates an example of the decision tree 120 for generating error codes according to some aspects of the present disclosure. The decision tree 120 includes nodes 222a-222f, beginning at a root represented by node 222a. Each of the nodes 222a-222f represents a function of the software application 110 and is associated with an identifier, shown in parentheses. The identifiers are illustrated as being an integer in FIG. 2, but other identifiers (e.g., letters, strings, symbols, etc.) are possible. As shown, node 222a is associated with the identifier “0”, node 222b is associated with the identifier “1”, node 222c is associated with the identifier “2”, node 222d is associated with the identifier “2”, node 222e is associated with the identifier “3”, and node 222f is associated with the identifier “3”.

In some examples, the decision tree 120 also includes edges 224a-224e between the nodes 222a-222f that indicate expected values for a given function. In FIG. 2, the edges 224a-224e are labeled with their expected values. For instance, edge 224b is associated with expected values of any string values, meaning that if a string value is output by the function of node 222b, the string value is used as an input value to the function of node 222d. In addition, edge 224c is associated with expected values of any other values (e.g., anything other than string values), meaning that if a non-string value is output by the function of node 222b, the non-string value is used as an input value to the function of node 222c. As another example, edge 224d has an expected value of “a<=1” meaning that if a value of a variable “a” that is output from the function of node 222d is less than or equal to 1, the value is used as an input value to the function of node 222e. In addition, edge 224e has an expected value of “a>1” meaning that if a value of the variable “a” that is output from the function of node 222d is greater than 1, the value is used as an input value to the function of node 222f. Each of the edges 224a-224e can also be associated with an identifier, illustrated as the edge identifiers in FIG. 2. As shown, edge 224a is associated with the identifier “0”, edge 224b is associated with the identifier “0”, edge 224c is associated with the identifier “1”, edge 224d is associated with the identifier “1”, and edge 224e is associated with the identifier “2”. Note that while the identifiers may be the same for some of the nodes 222a-222f and edges 224a-224e, the subset of identifiers that indicates the path of execution of the software application is different for each path.

In an example, if a string value results from the function of node 222b, the execution of the software application proceeds to the function of node 222d. Otherwise, the execution proceeds to the function of node 222c, which may indicate there is an error with an input to the software application. So, an error code (e.g., error code 130 in FIG. 1) can be generated for the error based on the decision tree 120 and the path of the execution. For instance, the error code resulting at the node 222c may be 0-0-1-0-2, indicating the path of execution from the node 222a, the edge 224a, the node 222b, the edge 224b, and the node 222c. In another example, the software application may execute until reaching the node 222e, where the execution may terminate due to an expected value being absent (e.g., as a result of insufficient testing). In this case, the error code may be 0-0-1-1-2-1-3, indicating the path of execution from the node 222a, the edge 224a, the node 222b, the edge 224c, the node 222d, the edge 224d, and the node 222e. As demonstrated, the error code can be a sequence of the identifiers for the functions executed prior to the error occurring. And, since the edges 224a-224e are associated with expected values, the error code also indicates the data associated with the path of the execution.

Returning to FIG. 1, to generate the decision tree 120, the computing device 102 (or other computing device) can receive the source code 112 indicating the functions 114 of the software application 110 and the expected values for the functions 114. The nodes 122 and the edges 124 can then be generated based on the source code 112 and the expected values, with each node and each edge being labelled with its identifier prior to the execution of the software application 110. Additionally or alternatively, the lines of the source code 112 of the software application may be enumerated with the identifiers. The branching of the nodes 122 and the edges 124 may be determined manually by a developer when developing functional testing for the software application 110, or with automation that can rely on static analysis or other techniques.

In some examples, once the computing device 102 determines the error code 130 that is associated with the error in the execution of the software application 110, and that indicates a path of the execution and the data associated with the path, the computing device 102 can perform an action 132 in response to the error code 130. For example, the computing device 102 may cause a notification of the error code 130 to be presented at a user interface of the computing device 102. In some cases, the notification may additionally indicate a cause of the error. For instance, if the software application 110 fails during an execution of a first function, the computing device 102 may determine that, based on the error code 130, the cause was an unexpected input value to the software application 110. The notification may additionally indicate the functions 114 that were executed prior to the error occurring.

In some instances, the action 132 may involve the computing device 102 outputting an indication of the error code 130 to the user device 104. The computing device 102 or a developer may determine a root cause of the error based on the error code 130. If the computing device 102 determines the root cause, the root cause can additionally be output to the user device 104. Upon receiving the indication of the error code 130 and the root cause, the user device 104 may receive an update to the software application or an update to the test suite 140 for the software application 110. For instance, the error code 130 may indicate that the test suite 140 is insufficient in detecting a case in which the software application 110 will fail because a resulting value for a function does not exist. The update to the test suite 140 can thus be a test for detecting the error such that the error can be identified prior to another execution of the software application 110.

While the user device 104 may receive the error code 130, the user device 104 may not receive the data associated with the path of execution unless a user provides approval at the computing device 102. For privacy and security purposes, the specific data passed during the execution may be prevented from being available to the user device 104. Additionally, since the edges 124 are associated with expected values, a developer may be able to accurately and efficiently determine the cause of the error without the data. But, the specific data may be beneficial for identifying the cause of the error in some cases. So, the computing device 102 may receive approval for sending the error code 130 along with the data to the user device 104. Upon receiving the approval, the computing device 102 can send the error code 130 and the data.

In some examples, the action 132 can involve the computing device 102 performing a lookup of the database 106 using the error code 130. The database 106 may store documentation for software applications. For instance, the documentation may provide information about known errors that occur for the software applications, how they may be fixed or avoided, or any other suitable information. So, in response to the lookup, the computing device 102 can receive documentation 134 associated with the error.

The lookup may involve a regular expression associated with the error code 130. The regular expression can be a sequence of characters that can be pattern matched in the database 106 to identify the documentation. By using regular expressions, multiple error codes may be directed to the same documentation. For example, during another execution of the software application 110, either by the computing device 102 or another computing device, another error may occur. This error may be associated with a different error code than the error code 130, depending on where in the execution the software application 110 failed. Even though the executions fail at different points, and thus have different error codes, looking up each of the error codes may result in the same documentation being provided. In addition, based on the error codes, a root cause of the error for both of the failures may be determined. The root cause can be the same for both errors and may be determined based on the paths of execution and the data associated with the paths.

The software application 110 may include, loops, recursions, runtime executed code, external executions, user interface applications with event response, or parallel processing. The decision tree 120 and error code generation may be able to handle each of these cases. For example, with regards to loops and recursion, the source code 112 may include additional identification, such as a special mark that indicates where the loops and recursion start and end in the source code 112. Such cases can be identified as one function and expected values as previously described. From an error code generation perspective, the loop and recursion are similar to an additional root. If an error code is to be generated from within one of the iterations, then the error code can be generated up to the loop and recursion with the value that was provided to the loop or recursion, and then an additional error code can be generated with a specific value in which the iteration failed. This can be done as many times as needed. A similar process may occur for the user interface applications, since these applications are running within an infinite while or recursion loop. Parallel execution can be handled in a similar way, where the computing device 102 receives an indication of how it was started and which version of the execution the error code was created in.

While FIG. 1 depicts a specific arrangement of components, other examples can include more components, fewer components, different components, or a different arrangement of the components shown in FIG. 1. For instance, in other examples, the decision tree 120 may be external to the computing device 102. Additionally, the user device 104 can be used to implement the process(es) described herein. In addition, static analysis or machine learning may be used to predict the input data and generate error codes without the use of a decision tree. But, since machine learning is not deterministic, user experience may be impacted. In addition, it may be difficult to develop a generic algorithm that is accurate across all programming languages and software development patterns.

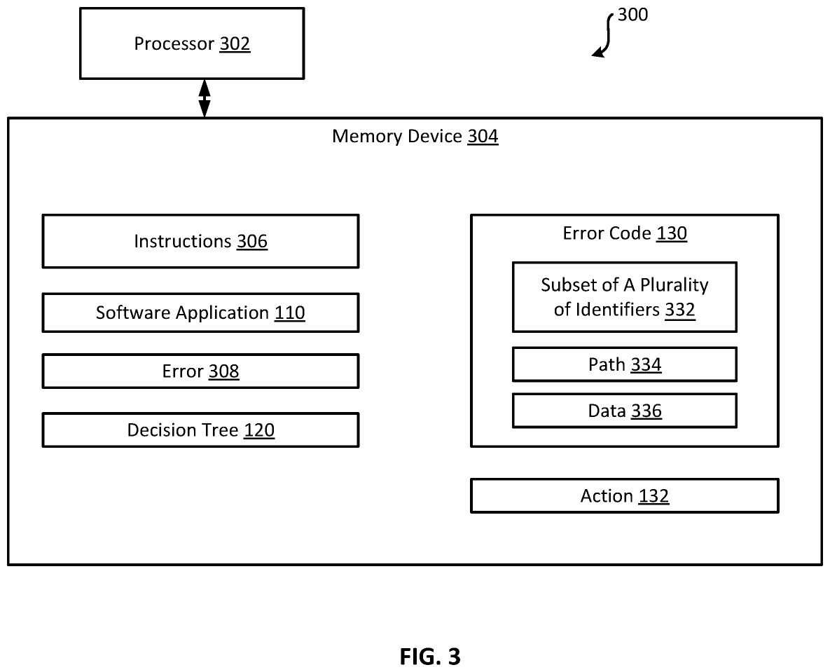

FIG. 3 is a block diagram of another example of a system 300 for error code generation for software application executions according to some aspects of the present disclosure. The system 300 can include a processor 302 communicatively coupled to a memory device 304.

The processor 302 can include one processing device or multiple processing devices. The processor 302 can be referred to as a processor. Non-limiting examples of the processor 302 include a Field-Programmable Gate Array (FPGA), an application-specific integrated circuit (ASIC), and a microprocessor. The processor 302 can execute instructions 306 stored in the memory device 304 to perform operations. In some examples, the instructions 306 can include processor-specific instructions generated by a compiler or an interpreter from code written in any suitable computer-programming language, such as C, C++, C#, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processor 302 can read instructions 306. A computer-readable medium can include electronic, optical, magnetic, or other storage devices capable of providing the processor 302 with the instructions 306 or other program code executable to perform operations. Non-limiting examples of a computer-readable medium include magnetic disk(s), memory chip(s), ROM, random-access memory (RAM), an ASIC, a configured processor, and optical storage.

In some examples, the processor 302 can execute the instructions 306 to perform operations. For example, the processor 302 can determine an error 308 in an execution of a software application 110 and uses a decision tree 120 to determine an error code 130 associated with the error 308. The error code 130 can be a subset of a plurality of identifiers 332 that indicates a path 334 of the execution of the software application 110 and data 336 associated with the path 334. To generate the decision tree 120, source code indicating functions of the software application can be received. In addition, an indication of a set of expected values for the functions can be received. Nodes representing the functions and edges representing the set of expected values can then be generated based on the source code and the indication of the set of expected values. Each node and each edge can also be associated with an identifier, such that the subset of the plurality of identifiers 332 can be determined. The processor 302 can perform an action 132 in response to the error code 130. For instance, the action 132 may involve determining a root cause for the error 308, looking up a database to determine documentation associated with the error 308, indicating the error code 130 to a developer device so that an update can be made to a test suite for the software application 110, or any other suitable action. By generating the error code 130 that indicates the path 334 of the execution as well as the data 336 involved in the execution, which is typically missing from traces and log entries, a root cause of the error may be efficiently identified and mitigated.

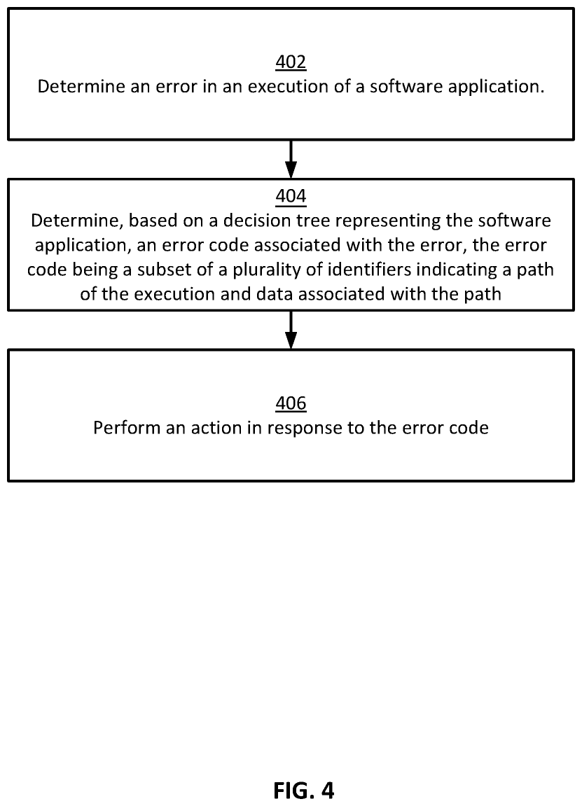

FIG. 4 is a flow chart of an example of a process for error code generation for software application executions according to some aspects of the present disclosure. In some examples, the processor 302 can perform one or more of the steps shown in FIG. 3. In other examples, the processor 302 can implement more steps, fewer steps, different steps, or a different order of the steps depicted in FIG. 3. The steps of FIG. 3 are described below with reference to components discussed above in FIGS. 1-3.

At block 402, the processor 302 can determine an error 308 in an execution of a software application 110. The processor 302 may determine a premature termination of the software application 110, a processing time of the software application 110 being larger than a threshold, or some other indicator of a failure in the software application 110. Based on the failure, the processor 302 can determine the occurrence of the error 308 in the execution.

At block 404, the processor 302 can determine, based on a decision tree 120 representing the software application 110, an error code 130 associated with the error 308. The error code 130 can be a subset of a plurality of identifiers 332 indicating a path 334 of the execution and data 336 associated with the path 334. The decision tree 120 can have nodes 122 and edges 124. The nodes 122 can represent functions 114 of the software application 110, while the edges 124 can represent expected values for the functions 114. That is, the edges 124 can represent accepted input data values for the functions 114. Each of the nodes 122 and the edges 124 can also be associated with an identifier, such that the subset of the plurality of identifiers 332 can be determined as the path 334 and the data 336 associated with the path 334. In this way, the error code 130 not only represents the functions that were executed prior to the error 308, but also the input data values that were passed during the execution. As a result, root causes of errors and mitigation actions may be more efficiently determined, resulting in reduced resource consumption for error processing operations.

At block 406, the processor 302 can perform an action 132 in response to the error code 130. For example, the processor 302 may cause a notification of the error code 130 to be presented at a user interface. The processor 302 may determine a root cause of the error based on the error code 130. In addition, the processor 302 may receive an update to the software application 110 or an update to a test suite 140 for the software application 110. The action 132 my additionally involve the processor 302 receiving an approval for sending the data 336 to another computing device. Upon receiving the approval, the processor 302 can send the error code 130 and the data 336 to the other computing device. As another example, the action 132 can involve the processor 302 performing a lookup of a database 106 using the error code 130 and receiving documentation 134 associated with the error in return.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processor; and
a memory device storing instructions that are executable by the processor for causing the processor to perform operations including:
determining an error in an execution of a software application;
determining, based on a decision tree representing the software application, an error code associated with the error, the error code being a subset of a plurality of identifiers indicating a path of the execution of the software application and data associated with the path; and
performing an action in response to the error code.

2. The system of claim 1, wherein each node of a plurality of nodes of the decision tree represents a function of the software application, each edge of a plurality of edges of the decision tree represents a set of expected values for the function, and each node and each edge is associated with an identifier of the plurality of identifiers, and wherein the operations further comprise:
accessing the decision tree to determine the error code, wherein the decision tree is configured to be generated by:
receiving source code indicating a plurality of functions of the software application;
receiving an indication of the set of expected values for the plurality of functions; and
generating the plurality of nodes and the plurality of edges based on the source code and the set of expected values, wherein each node and each edge is labelled with the identifier prior to the execution of the software application.

3. The system of claim 1, wherein performing the action comprises:
outputting an indication of the error code to a user device, wherein the user device is configured to provide an update to a test suite for the software application, and wherein the update comprises a test for detecting the error prior to a subsequent execution of the software application.

4. The system of claim 1, wherein performing the action comprises:
performing a lookup of a database using the error code; and
receiving documentation associated with the error in response to the lookup.

5. The system of claim 4, wherein the lookup comprises a regular expression associated with the error code.

6. The system of claim 1, wherein the execution is a first execution, the error is a first error, and the error code is a first error code, and wherein the operations further comprise:
in response to a second execution of the software application, determining a second error in the second execution;
determining a second error code associated with the second error based on the decision tree, the second error code being a different subset of the plurality of identifiers than the subset of the plurality of identifiers for the first error code; and
determining, based on the first error code and the second error code, a root cause of the first error and the second error.

7. The system of claim 1, wherein the operations further comprise:
receiving an approval to send the error code and the data to a user device; and
in response to receiving the approval, sending the error code and the data to the user device.

8. A computer-implemented method comprising:
determining an error in an execution of a software application;
determining, based on a decision tree representing the software application, an error code associated with the error, the error code being a subset of a plurality of identifiers indicating a path of the execution of the software application and data associated with the path; and
performing an action in response to the error code.

9. The computer-implemented method of claim 8, wherein each node of the decision tree represents a function of the software application, each edge of the decision tree represents a set of expected values for the function, and each node and each edge is associated with a identifier of the plurality of identifiers, and wherein the computer-implemented method further comprises:
accessing the decision tree to determine the error code, wherein the decision tree is configured to be generated by:
receiving source code indicating a plurality of functions of the software application;
receiving an indication of the set of expected values for the plurality of functions; and
generating the plurality of nodes and the plurality of edges based on the source code and the set of expected values, wherein each node and each edge is labelled with the identifier prior to the execution of the software application.

10. The computer-implemented method of claim 8, wherein performing the action comprises:
outputting an indication of the error code to a user device, wherein the user device is configured to provide an update to a test suite for the software application, and wherein the update comprises a test for detecting the error prior to a subsequent execution of the software application.

11. The computer-implemented method of claim 8, wherein performing the action comprises:
performing a lookup of a database using the error code; and
receiving documentation associated with the error in response to the lookup.

12. The computer-implemented method of claim 11, wherein the lookup comprises a regular expression associated with the error code.

13. The computer-implemented method of claim 8, wherein the execution is a first execution, the error is a first error, and the error code is a first error code, and wherein the operations further comprise:
in response to a second execution of the software application, determining a second error in the second execution;
determining a second error code associated with the second error based on the decision tree, the second error code being a different subset of the plurality of identifiers than the subset of the plurality of identifiers for the first error code; and
determining, based on the first error code and the second error code, a root cause of the first error and the second error.

14. The method of claim 8, wherein the operations further comprises:
receiving an approval to send the error code and the data to a user device; and
in response to receiving the approval, sending the error code and the data to the user device.

15. A non-transitory computer-readable medium comprising program code that is executable by a processor for causing the processor to perform operations including:
determining an error in an execution of a software application;
determining, based on a decision tree representing the software application, an error code associated with the error, the error code being a subset of a plurality of identifiers indicating a path of the execution of the software application and data associated with the path; and
performing an action in response to the error code.

16. The non-transitory computer-readable medium of claim 15, wherein each node of the decision tree represents a function of the software application, each edge of the decision tree represents a set of expected values for the function, and each node and each edge is associated with an identifier of the plurality of identifiers, and wherein the operations further comprise:
accessing the decision tree to determine the error code, wherein the decision tree is configured to be generated by:
receiving source code indicating a plurality of functions of the software application;
receiving an indication of the set of expected values for the plurality of functions; and
generating the plurality of nodes and the plurality of edges based on the source code and the set of expected values, wherein each node and each edge is labelled with the identifier prior to the execution of the software application.

17. The non-transitory computer-readable medium of claim 15, wherein the action comprises:
outputting an indication of the error code to a user device, wherein the user device is configured to provide an update to a test suite for the software application, and wherein the update comprises a test for detecting the error prior to a subsequent execution of the software application.

18. The non-transitory computer-readable medium of claim 15, wherein performing the action comprises:
performing a lookup of a database using the error code; and
receiving documentation associated with the error in response to the lookup.

19. The non-transitory computer-readable medium of claim 15, wherein the execution is a first execution, the error is a first error, and the error code is a first error code, and wherein the operations further comprise:
in response to a second execution of the software application, determining a second error in the second execution;
determining a second error code associated with the second error based on the decision tree, the second error code being a different subset of the plurality of identifiers than the subset of the plurality of identifiers for the first error code; and
determining, based on the first error code and the second error code, a root cause of the first error and the second error.

20. The non-transitory computer-readable medium of claim 15, wherein the operations further comprise:
receiving an approval to send the error code and the data to a user device; and
in response to receiving the approval, sending the error code and the data to the user device.
